(19) United States
(12) Patent Application Publication
(10) Pub. No.: US 2011/0227525 A1
(43) Pub. Date: Sep. 22, 2011

(54) Charging Circuit, Method, and System

(75) Inventors: Eric Blackall, Richardson, TX (US); James Kohout, Dallas, TX (US); Ross Teggatz, McKinney, TX (US); Wayne Chen, Plano, TX (US)

(73) Assignee: TRIUNE IP LLC, Richardson, TX (US)

(21) Appl. No.: 13/008,712

(22) Filed: Jan. 18, 2011

Related U.S. Application Data
(60) Provisional application No. 61/295,707, filed on Jan. 16, 2010.

(51) Int. Cl. H02J 7/04

(52) U.S. Cl. 320/107; 320/162

(57) ABSTRACT

The invention provides methods, circuits and systems for charging batteries and other storage media including methods steps and apparatus for monitoring one or more parameters such that a charger may be operated in a first mode to deliver charge to the storage medium and/or load, and when at least one of the monitored parameters reaches a selected threshold level, the operation of the charger in the first mode is terminated in favor of operation in a second mode, delivering a different level of charge from the charger.

### PRIORITY ENTITLEMENT

This application is entitled to priority based on Provisional Patent Application Ser. No. 61/295,707, filed on Jan. 16, 2010, which is incorporated herein for all purposes by this reference. This application and the Provisional Patent Application have at least one common inventor.

### TECHNICAL FIELD

The invention relates to energy harvesting and to the more efficient utilization of energy resources. In particular, the invention is directed to power control methods, systems, and circuitry designed to facilitate the implementation of charging controllers. More particularly, the invention relates to charging systems having multiple operating modes.

### BACKGROUND OF THE INVENTION

Charging methods, systems and apparatus are often required to perform tasks to include, delivering a charging current to a battery (or other energy storage medium such as capacitors, or arrays of batteries or capacitors), optimizing the charging rate, and terminating charging when appropriate. Power for charging may be derived from a number of sources. In some instances, a power supply at a fixed voltage is available. In other cases, a variable power supply may be used, such as a photovoltaic energy harvesting system or other potentially variable power source. Once a battery is fully charged, the excess energy generated by the system must be dissipated, since overcharging is generally detrimental to batteries. The generation of waste heat sometimes results, which can also be detrimental to circuitry and batteries. An attribute of successful charging circuits, systems, and methods, is detection of when the charging is complete in order to stop the charging process to prevent overcharging while maintaining the cell temperature within its safe limits at all times. Detecting the appropriate cut-off point and curtailing charging accordingly contributes to system efficiency and extends battery life. Conversely, it is desirable to maximize charging when it is possible to do so within the limits imposed by the battery and associated circuitry.

Battery charging approaches known in the arts include various techniques for providing a controlled charge to a battery, or equivalently, an array of batteries, or suitable storage capacitors. One common approach is to use a constant voltage, essentially a direct current power supply with a step down transformer, in combination with a rectifier to provide the DC voltage to charge the battery. Such designs are often used to charge lead-acid cells. Commonly, the battery and a load are permanently connected in parallel across the DC charging source and efforts are made to hold the battery at a constant voltage level at or slightly below the battery's upper voltage limit. Constant current chargers, often used for nickel-cadmium and nickel-metal hydride cells, vary the voltage they apply to the battery in order to maintain a constant flow of charging current. In one variation, pulsed chargers provide charging current to the battery in pulses. The charging rate is controlled by varying the width of the pulses. Short periods between pulses allow the chemical reactions in the battery to stabilize before the next charging pulse in efforts to enable the chemical reactions within the battery to keep pace with the rate of electrical energy input. The above charging approaches, and prevailing charging schemes used in the art in general, involve providing a controlled charge to the battery based on the assumption that a steady power source is more-or-less constantly available. However, there are applications in which the energy to charge the battery is only available, or may only be delivered, on a more intermittent, variable, or even random basis. This applies to some vehicle applications, for example, where the available energy may depend on the speed of operation of a mechanical engine, which may frequently be changed. The problem of variations in available energy is also present in applications which use regenerative braking systems to generate electrical energy, since this creates relatively large power spikes during braking, which the battery must absorb if the energy is to be harvested. In other applications, such as in solar energy collection systems, available energy for charging may vary significantly and frequently due to weather conditions and time of day. These variable power scenarios have in common the need for techniques to maximize charging during periods of low available energy, and to limit the charging current and/or voltage to levels the battery can tolerate without damage when excess energy is available.

Due to these and other problems and potential problems with the current state of the art, improved chargers and voltage regulators powered with variable energy sources, photovoltaic solar systems, for example, could benefit from having the capability of running in multiple operational modes depending on conditions such as the voltage and current available from the solar cells, the charge level of the storage medium, and/or the system load. It would be useful and advantageous for methods, circuits, and systems to be adapted to monitor parameters related to load and power conditions in order to dynamically determine and implement the correct mode of operation in real time.

### SUMMARY OF THE INVENTION

In carrying out the principles of the present invention, in accordance with preferred embodiments, the invention provides advances in the arts with novel methods and apparatus directed to providing charging regulation adaptable to available power, load, and storage medium requirements and limitations based on monitored conditions. For convenience, the term “battery” is used herein to refer to media for the storage of electrical energy in general, including but not necessarily limited to chemical batteries and storage capacitors as well as arrays of the same.

According to one aspect of the invention, a preferred embodiment of a charging method includes steps for monitoring one or more battery parameters such that a charger may be operated in a first mode to deliver charge to the battery. In a further step, when at least one of the monitored battery parameters reaches a selected threshold level, the operation of the charger in the first mode is terminated in favor of operating the charger in a second mode, delivering charge from the charger to the battery.

According to another aspect of the invention, preferred embodiments of a battery charging method include an implementation in which battery voltage and one or more additional battery parameters are monitored. Charge is delivered from a charger to the battery at a selected maximum power point current level until the monitored battery voltage reaches a selected voltage level. In a further step, the delivery of charge current to the battery at the maximum power point current level is terminated and the current delivered to the battery is regulated at a selected level less than the maximum power point current level.

According to still another aspect of the invention, in an example of a preferred battery charging method, steps are included for monitoring battery voltage and one or more additional battery parameters. Steps include delivering charging current from the charger to the battery at a maximum power point current level until a selected maximum voltage level is reached, whereupon delivery of charging current to the battery is clamped at the maximum power point current level. Thereafter, voltage delivered to the battery is regulated to a selected maximum level.

According to another aspect of the invention, in examples of preferred embodiments, a disclosed battery charging method includes steps for monitoring battery voltage and additional battery parameters. Charging current is delivered from charger to battery at a selected maximum power point current level. In further steps, a comparator compares the monitored battery voltage to a voltage threshold, and upon reaching the threshold, delivery of charging current to the battery at the selected maximum power point current level is terminated. Subsequently, power delivered to the battery is regulated to a selected maximum level.

According to another aspect of the invention, examples of preferred embodiments include a battery charger having a battery and monitoring circuitry for monitoring selected battery parameters. A charger coupled to the battery is adapted to operate in a first mode, delivering a charge to the battery. The charger is also adapted to operate in a second mode in response to one or more of the monitored battery parameters reaching a threshold level, delivery another level of charge to the battery.

According to additional aspects of the invention, the battery charger described in preferred embodiments is implemented in combination with one or more of, energy harvesting apparatus, communications apparatus, computing apparatus, imaging apparatus, display apparatus, audio apparatus, and vehicular apparatus.

The invention has advantages including but not limited to one or more of the following, energy harvesting efficiency, energy storage efficiency, storage medium protection, and system durability. These and other advantageous features and benefits of the present invention can be understood by one of ordinary skill in the arts upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is a simplified schematic circuit diagram illustrating an example of preferred embodiments of charging circuits, systems, and methods;

FIG. 2 is a simplified schematic circuit diagram illustrating an example of alternative preferred embodiments of charging circuits, systems, and methods; and

FIG. 3 is a simplified schematic circuit diagram illustrating an example of alternative preferred embodiments of charging circuits, systems, and methods.

References in the detailed description correspond to like references in the various drawings unless otherwise noted. Descriptive and directional terms used in the written description such as right, left, back, top, bottom, upper, side, et cetera, refer to the drawings themselves as laid out on the paper and not to physical limitations of the invention unless specifically noted. The drawings are not to scale, and some features of embodiments shown and discussed are simplified or amplified for illustrating principles and features, as well as anticipated and unanticipated advantages of the invention.

### DESCRIPTION OF PREFERRED EMBODIMENTS

The present invention is related to U.S. patent application Ser. No. 12/833,997 and PCT/US10/55338, and has one or more inventors and an assignee in common with the same. These related applications are incorporated herein for all purposes by this reference. It has been observed that chargers provided with consumer electronics devices such as mobile phones and portable computer apparatus generally are designed to simply provide a fixed voltage source. The required voltage and current profiles for controlling the charging of the battery is provided with electronic circuitry, either within the device itself or within the battery pack. Providing chargers with multiple operational modes would provide increased compatibility among chargers, storage media, and electronic apparatus. These multiple operational modes may advantageously include regulating the charging system to provide the maximum output power, or maximum power point (MPP), operate with a given input voltage, deliver a selected output voltage, or deliver a selected output current to the battery. It would be advantageous for methods and systems to monitor battery and/or circuit parameters in order to dynamically determine the preferred mode of operation under prevailing real time conditions.

Charger circuitry may include one or more types of circuits designed to control charging according to different circumstances. Chargers generally include a form of voltage regulation to control the charging voltage applied to the battery. The choice of charger circuit technology is an engineering trade-off based on predicted performance based on expected operating conditions. Examples include a switch mode power supply (SMPS). A SMPS uses pulse width modulation to control the voltage supplied to the battery. Its characteristics include low power dissipation over wide variations in input voltage and battery voltage. An output filter is used to smooth the output waveform. A series regulator is generally less complex and smaller than a SMPS, but more lossy, requiring a heat sink to dissipate heat generated in the series, and a voltage reducing transistor to divert the difference between the supply voltage and the output voltage. All load current passes through the regulating transistor, which consequently must be a relatively high power device. Since there is no switching, the series regulator delivers pure DC without the need for an output filter. Another charging approach suitable in photovoltaic (PV) systems, the shunt regulator is relatively cheap to build and simple to design. The charging current is controlled by a switch or transistor connected in parallel with the photovoltaic panel and the storage battery. Overcharging of the battery is prevented by shunting the PV output current through the transistor when the voltage reaches a predetermined limit. If the battery voltage exceeds the PV supply voltage the shunt will also protect the PV panel from being damaged by reverse voltage by discharging the battery through the shunt. Series regulators generally have better control and charge characteristics than shunt regulators.

Charging a battery or other storage medium in applications when energy is available only intermittently may be improved by providing multiple charging modes selectable according to conditions. Since variations in energy availability and variations in power levels may occur, battery parameters such as voltage and current are preferably monitored to protect the battery from being subjected to overvoltage. Typical applications include solar and wind power systems, onboard vehicle chargers such as alternators and regenerative braking, and inductive chargers, such as may be available for portable devices or on electric vehicle stopping points. During charging, battery voltage is preferably measured across the charger leads. For high current chargers, however, there can be a significant voltage drop along the charger leads, resulting in an unduly low reading less than the actual battery voltage, resulting in undercharging of the battery if the battery voltage is used as the cut-off trigger. In such implementations, it is preferable to measure the voltage directly across the battery terminals. Since there is generally a risk of overcharging the battery, monitoring battery temperature may also be used as a trigger to turn off or disconnect the charger when high temperatures appear. This avoids damage to the battery, since overcharging is often accompanied by rising temperatures, increasing safety and avoiding potential damage to the battery. Monitoring charging time can also be used to provide an additional safeguard.

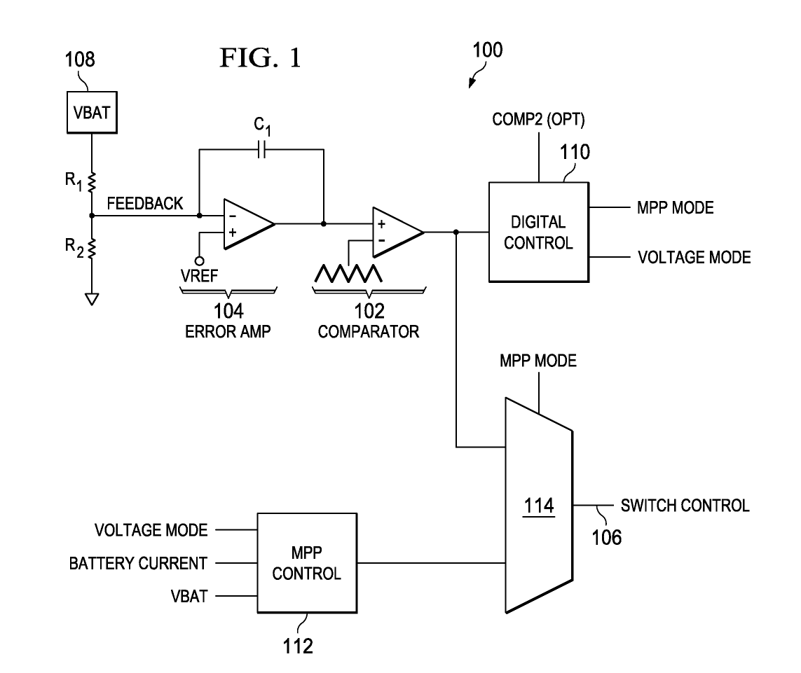

According to preferred embodiments of charging methods, systems, and circuits of the invention, to ensure proper battery charging, the battery voltage, charging current, charging time, and battery temperature are preferably monitored. The monitoring can vary based on the type of battery being charged. Li-ion, Ni—MH, lead-acid and other battery types have different requirements and tolerances. Before the final battery termination voltage is reached, regulation of the output power or input voltage is performed to maximize the charging current delivered to the output, known as a maximum power point (MPP) charging approach. Under such a scheme, output current is maximized, insofar as practical, unless the available current is greater than the safe charging current of the battery. In the case of greater available current, output current is regulated to the maximum safe charging current of the battery. Once the termination voltage of the battery is reached, the charging system preferably switches to a voltage or output current regulation in order to avoid over-charging the battery. In a first preferred embodiment, as depicted in the simplified schematic of FIG. 1, selected switch mode power supply (SMPS) control methods and circuits may be used with either a comparator or an integrating error amplifier in combination with a comparator. In one presently preferred embodiment, as shown, this SMPS control is capable of being performed in parallel with MPP regulation. Electrical and physical parameters are preferably monitored at the battery, and once the battery voltage (VBAT) reaches its termination voltage, and/or other selected threshold, the controller begins to shorten the SMPS duty cycle. Once this shortening is required for a predetermined number of clock cycles, e.g., one or multiple clock cycles, depending upon the selection made for the particular implementation, the MPP controller is shut off and SMPS voltage regulation is carried out subsequently. Alternatively, the monitored parameter(s) may be used to detect the end of conditions favoring MPP regulation, and output current regulation or some other alternative regulation mode may be commenced. In either case, MPP control may be restarted again if correct output voltage cannot otherwise be attained. Monitored parameters may include voltage, current, and temperature, as well as other characteristics.

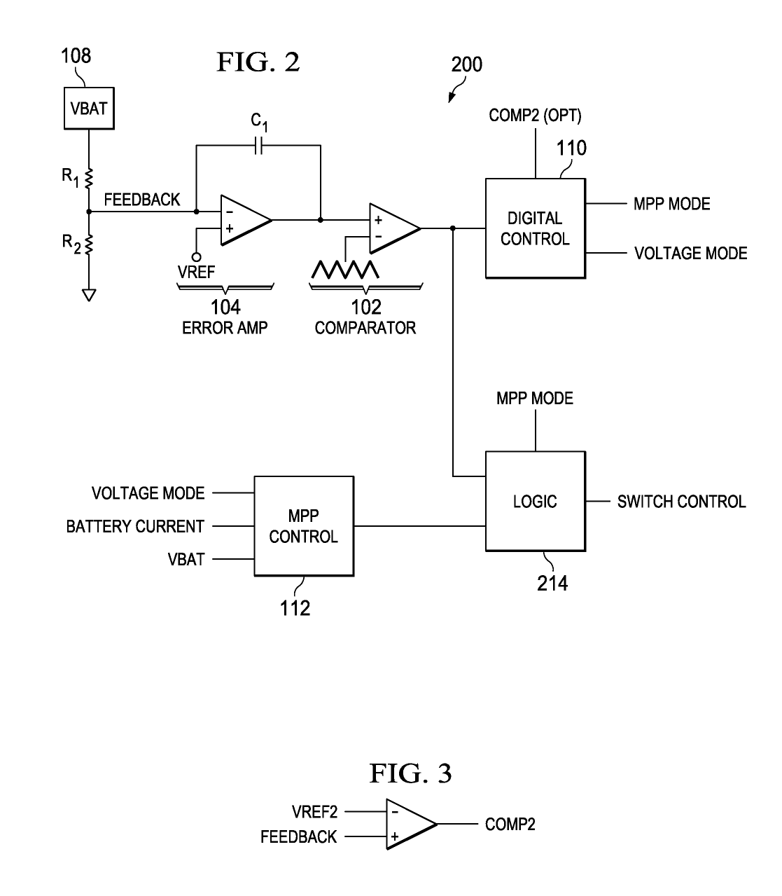

In another alternative embodiment, both MPP and voltage regulation may be continued in parallel after voltage regulation begins to shorten duty cycle, with MPP control being modified as necessary in order to prevent detrimental interference with voltage regulation. This approach essentially clamps the MPP duty cycle in order to control the voltage at the output. This information is in turn fed back to the MPP controller to maximize the output power, so long as monitored parameters do not indicate that this would cause a disruption in regulated output voltage. In such a case, the MUX shown in the exemplary implementation of FIG. 1 may alternatively be replaced with suitable Boolean function and/or combinational logic element(s), as indicated in FIG. 2.

In an example of another alternative embodiment, an additional comparator is provided in order to determine when the battery termination voltage reaches a predetermined threshold level. Upon reaching the selected threshold, voltage regulation is begun. This approach is illustrated in FIG. 3. This technique may be used to provide a fast transition between charging modes in order to minimize the chance of inflicting an overvoltage condition on the battery. In this case, VREF2 may or may not be equal to VREF in order to sense whether the voltage is exactly the same as, or above or below, the appropriate termination voltage. A separate resistor stack or similar alternative feedback point may also be used to accomplish the equivalent function. The switching output and duty cycle control for the MPP/voltage mode loop works from an input decision based on Error Amp output or the MPP control. The Error Amplifier output may be supplied from a variety of types of architectures such as current mode, voltage mode, bang-bang mode, hysteretic, resonant, linear, and other types of feedback. Alternatively, or additionally, a comparator may be used to monitor the charger voltage available for input to the energy storage medium. Using a selected threshold, this comparator may be used to adjust the MPP level when there is a change in input conditions, such as a decrease in the available power for charging. It should be understood that various combinations of input and output monitoring may likewise be used to dynamically adapt the MPP level according to real time conditions. Comparators may also be used to monitor charger input and output conditions, such as, duty cycle, frequency, pulse width, and the like in order to provide dynamic charger system mode selection. The control loop for MPP optimization charging and voltage top-off may be modified to other types of optimization schemes and applied to the switching/cross-over concept as described above. As a result, this method and system may be applied to other types of energy regeneration or conventional power systems wherein a battery or other storage medium is charged. In addition to controlling the voltage and current profile of the charger output during the energy storage process, the system and methods described may also be used to isolate a selected battery when monitored parameters suggest a major fault, for switching on supplemental solar, regenerative braking, or other intermittently available power supplies when required, and for turning off or shunting excessive power when an associated system is fully charged.

While the making and using of various exemplary embodiments of the invention are discussed herein, it should be appreciated that the present invention provides inventive concepts which can be embodied in a wide variety of specific contexts. It should be understood that the invention may be practiced with various types of batteries, or other energy storage media such as capacitors, for example, without altering the principles of the invention. For purposes of clarity, detailed descriptions of functions, components, and systems familiar to those skilled in the applicable arts are not included. The methods and apparatus of the invention provide one or more advantages including but not limited to, providing efficient energy harvesting and utilization using variable power sources for charging energy storage media. The charging methods, circuits, and systems provide multiple dynamic power regulation control modes of operation selectable based on monitored real time conditions. While the invention has been described with reference to certain illustrative embodiments, those described herein are not intended to be construed in a limiting sense. For example, variations or combinations of steps or materials in the embodiments shown and described may be used in particular cases without departure from the invention. Various modifications and combinations of the illustrative embodiments as well as other advantages and embodiments of the invention will be apparent to persons skilled in the arts upon reference to the drawings, description, and claims.

We claim:

1. A battery charging method comprising the steps of:
monitoring one or more battery parameters;
operating a charger in a first mode, delivering a charge from the charger to the battery;
when one or more of the monitored battery parameters reaches a selected threshold level, terminating the operation of the charger in the first mode, and thereafter;
operating the charger in a second mode, delivering a charge from the charger to the battery.

2. The battery charging method according to claim 1 wherein operating the charger in the first mode further comprises the step of regulating charge delivered to the battery at a selected maximum power point level.

3. The battery charging method according to claim 1 wherein operating the charger in the second mode further comprises the step of regulating charge delivered to the battery at a selected switch mode power supply level.

4. The battery charging method of claim 1 wherein the monitored battery parameters consist of one or more of: voltage; charging current; charging time; charging pulse width; charging frequency; charging duty cycle; or temperature.

5. A battery charging method comprising the steps of:
monitoring battery voltage;
monitoring one or more additional battery parameters;
delivering charge from a charger to the battery at a selected maximum power point current level;
when the monitored battery voltage reaches a selected voltage level, terminating the delivery of charge current to the battery at the selected maximum power point current level; and thereafter,
using the one or more monitored battery parameters, regulating the current delivered to the battery at a selected level less than the maximum power point current level.

6. A battery charging method comprising the steps of:
monitoring battery voltage;
monitoring one or more additional battery parameters;
delivering charging current from the charger to the battery at a selected maximum power point current level;
when the monitored battery voltage reaches a selected maximum voltage level, clamping the delivery of charging current to the battery at the selected maximum power point current level; and thereafter,
delivering a voltage at the battery wherein said voltage is regulated to a selected maximum level.

7. A battery charging method comprising the steps of:
monitoring battery voltage;
monitoring one or more additional battery parameters;
delivering charging current from the charger to the battery at a selected maximum power point current level;
using a comparator, comparing the monitored battery voltage to a selected voltage threshold, and upon reaching said threshold, terminating the delivery of charging current to the battery at the selected maximum power point current level; and thereafter,
delivering power at the battery wherein said power is regulated to a selected maximum level.

8. The battery charging method according to claim 7 comprising the further step of:
using a comparator, comparing the monitored battery voltage to the available input voltage level, and adjusting the maximum power point current level in response to the monitored input voltage level.

9. A battery charger comprising:
a battery;
monitoring circuitry operably coupled to monitor one or more battery parameters;
a charger operably coupled to the battery, wherein the charger is adapted to operate in a first mode, delivering a charge to the battery; and wherein
the charger is adapted to operate in a second mode in response to one or more of the monitored battery parameters reaching a threshold level, delivering a charge to the battery.

10. The battery charger according to claim 9 wherein the charger further comprises a SMPS charger.

11. The battery charger according to claim 9 wherein the charger further comprises a SMPS having maximum power regulation.

12. The battery charger according to claim 9 wherein the charger further comprises a SMPS having maximum output current regulation.

13. The battery charger according to claim 9 wherein the charger further comprises a SMPS having maximum output voltage regulation.

14. The battery charger according to claim 9 wherein the charger further comprises digital control circuitry operable for mode selection.

15. The battery charger according to claim 9 in combination with energy harvesting apparatus.

16. The battery charger according to claim 9 in combination with communications apparatus.

17. The battery charger according to claim 9 in combination with computing apparatus.

18. The battery charger according to claim 9 in combination with imaging apparatus.

19. The battery charger according to claim 9 in combination with display apparatus.

20. The battery charger according to claim 9 in combination with audio apparatus.

21. The battery charger according to claim 9 in combination with vehicular apparatus.

22. The battery charger according to claim 9 further comprising at least one comparator operably coupled to the charger for selecting a first or second operating mode.
